(19) United States
(12) Patent Application Publication
(10) Pub. No.: US 2025/0332747 A1
(43) Pub. Date: Oct. 30, 2025

(54) SELF-DEFENSE DEVICE

(71) Applicant: Sleeping Tiger, Ltd., Mundelein, IL (US)

(72) Inventors: Deborah A. Donahoe, Mundelein, IL (US); David E. Machamer, Wauconda, IL (US)

(21) Appl. No.: 19/182,092

(22) Filed: Apr. 17, 2025

Related U.S. Application Data
(63) Continuation-in-part of application No. 18/055,120, filed on Nov. 14, 2022, now Pat. No. 12,296,494.

(51) Int. Cl. B26B 1/04

(52) U.S. Cl. CPC B26B 1/042

(57) ABSTRACT

A self-defense device includes a handle, a body, an arm, and a blade. The handle is coupled to the body. The arm is coupled to the body and to the blade. The handle, the arm, and the blade are each configured to move relative to the body between a retracted position and an extended position. A releasable latch is configured to hold the handle in the retracted position.

### CROSS-REFERENCE TO RELATED APPLICATIONS

This application is a continuation-in-part of U.S. patent application Ser. No. 18/055,120, filed on Nov. 14, 2022, now allowed, which is incorporated herein by reference in its entirety.

### TECHNICAL FIELD

The present disclosure relates generally to self-defense devices and, more particularly, to a self-defense device featuring a collapsible handle and blade.

### BACKGROUND

In an attack situation, a victim lacking other options will often resort to clawing with their fingernails--particularly when the attacker approaches from behind and places their arm(s) across or around the victim's neck, chest or waist. While a victim's use of fingernails shows a determined willingness to fight back and ability to make contact at close range, it often results in broken and deeply torn fingernails with little damage to the attacker. Thus, a victim can benefit by possessing a tool or weapon that can be employed using an instinctive pulling/clawing action (similar to the use of fingernails), but capable of inflicting damage more likely to repel an attack.

Numerous self-defense devices exist, but many fall short in panic situations involving minimal distance from the attacker or little time to react. Many conventional devices, such as Tasers or pepper spray devices, must be aimed and require sufficient distance from the attacker. Further, such devices are often rendered ineffective when the victim is restrained from behind. Other conventional devices, such as tactical pens, telescoping batons and keychain pressure devices require skill or strength, thereby limiting their usefulness.

While self-defense blades or knifes are available, most such devices are not designed to take advantage of the instinctive clawing or pulling motion described above. Further, such devices could be dropped or turned against a user under duress. Further, users may be unable to access conventional devices quickly enough if carried in a pocket or purse.

Thus, the need exists for a wearable self-defense apparatus providing a high state of readiness for sudden close contact attack that is instinctively simple to deploy and use, safe for the user, safe-guarded against dropping or being used by the attacker, and compact with a pleasing form-factor.

### SUMMARY

The term embodiment and like terms, e.g., implementation, configuration, aspect, example, and option, are intended to refer broadly to all of the subject matter of this disclosure and the claims below. Statements containing these terms should be understood not to limit the subject matter described herein or to limit the meaning or scope of the claims below. Embodiments of the present disclosure covered herein are defined by the claims below, not this summary. This summary is a high-level overview of various aspects of the disclosure and introduces some of the concepts that are further described in the Detailed Description section below. This summary is not intended to identify key or essential features of the claimed subject matter. This summary is also not intended to be used in isolation to determine the scope of the claimed subject matter. The subject matter should be understood by reference to appropriate portions of the entire specification of this disclosure, any or all drawings, and each claim.

According to certain aspects of the present disclosure, a self-defense device includes a handle, a body, an arm, and a blade. The handle is coupled to the body. The arm is coupled to the body and to the blade. The handle, the arm, and the blade are each configured to move relative to the body between a retracted position and an extended position. A releasable latch is configured to hold the handle in the retracted position.

According to some features of the above aspects, the self-defense device further includes a foot pivotably coupled to a distal end of the handle. The foot is configured to pivot relative to the handle between a retracted position and an extended position. The foot is held in the retracted position by the releasable latch.

According to some features of the above aspects, the releasable latch includes a latch stud that extends from the body, and a latch key coupled to the foot. The latch key is movable between an engaged position with the latch stud and a disengaged position with the latch stud.

According to some features of the above aspects, the self-defense device further includes a latch spring coupled to the foot. The latch spring is configured to bias the latch key toward the engaged position with the latch stud.

According to some features of the above aspects, the self-defense device further includes a release plunger slidably coupled to the foot. The release plunger is in contact with the latch key, and is movable between a first position wherein the latch key is in the engaged position with the latch stud and a second position wherein the latch key is in the disengaged position with the latch stud.

According to some features of the above aspects, the retracted position of the arm and the retracted position of blade are each substantially disposed within a perimeter of the body. The blade has an outer edge that is shaped to substantially match the perimeter of the body. The retracted position of the handle is at least partially disposed within the perimeter of the body.

According to some features of the above aspects, the arm comprises a linkage mechanism including opposing first and second linkage elements. Each of the first and second linkage elements is pivotally coupled at a first end to the body and pivotally coupled at a second end to the blade such that each of the first and second linkage elements is configured to pivot between a retracted position substantially inside the body and an extended position extending outside of the body.

According to some features of the above aspects, the self-defense device further includes a release button disposed within the first linkage element. The release button is movable relative to a surface of the first linkage element between a raised position and a lowered position. When the release button is in its raised position and the arm is in its retracted position, the release button interferes with the body to prevent the arm from moving toward its extended position.

According to some features of the above aspects, the body further includes an elongated channel configured to slidably receive and house the handle in its retracted position. The handle in its retracted position makes contact with the release button when the release button is in its raised position and the arm is in its retracted position, thereby preventing the release button from moving from its raised position to its lowered position. The handle in its extended position does not contact the release button when the release button is in its raised position and the arm is in its retracted position, thereby permitting the release button to be moved from its raised position to its lowered position.

According to some features of the above aspects, the self-defense device further includes a depressible trigger plate movable relative to the body between raised and lowered positions. The depressible trigger plate is in contact with the release button when the release button is in its raised position and the arm is in its retracted position. Movement of the depressible trigger plate toward its lowered position when the handle is in its extended position causes the release button to move toward its lowered position.

According to some features of the above aspects, when the release button is in its lowered position and the arm is in its retracted position, the arm is free to move toward its extended position.

According to certain aspects of the present disclosure, a self-defense device includes a foot, a handle, a body, an arm, and a blade. The foot is coupled to the handle. The handle is coupled to the body. The arm is coupled to the body and to the blade. The foot, the handle, the arm, and the blade are each configured to move relative to the body between a retracted position and an extended position. A releasable latch is configured to hold the foot and the handle in their retracted positions.

According to some features of the above aspects, the foot is pivotally coupled to a distal end of the handle and configured to pivot relative to the handle between the retracted position and the extended position. A first resilient member is configured to bias the foot toward its extended position.

According to some features of the above aspects, the body further includes an elongated channel configured to slidably receive and house the handle is in its retracted position. The elongated channel is configured to house a second resilient member that biases the handle toward its extended position.

According to some features of the above aspects, the releasable latch includes a latch stud that extends from the body, a latch key coupled to the foot, a release plunger slidably coupled to the foot, and a latch spring coupled to the foot. The latch key is movable between an engaged position with the latch stud and a disengaged position with the latch stud. The release plunger is in contact with the latch key. The release plunger is movable between a first position wherein the latch key is in the engaged position and a second position wherein the latch key is in the disengaged position. The latch spring is configured to bias the latch key toward the plunger.

According to some features of the above aspects, the arm includes a linkage mechanism including opposing first and second linkage elements. Each of the first and second linkage elements is pivotally coupled at a first end to the body and pivotally coupled at a second end to the blade such that each of the first and second linkage elements is configured to pivot between a retracted position substantially inside the body and an extended position extending outside of the body. A third resilient member is configured to bias the first linkage element toward its extended position.

According to some features of the above aspects, the foot is curved and the blade has a curved cutting edge, such that both the foot in its extended position the blade in its extended position extend in a direction transverse to a centerline of the handle in its extended position.

According to certain aspects of the present disclosure, a self-defense device includes a foot, a handle, a body, an arm, and a blade. The foot is coupled to the handle. The handle is coupled to the body. The arm is coupled to the body and to the blade. The foot, the handle, the arm, and the blade are each configured to move relative to the body between a retracted position and an extended position. A releasable latch is configured to hold the foot and the handle in their retracted positions. A first resilient member biases the blade and the arm toward their extended positions. A second resilient member biases the handle toward its extended position. A third resilient member biases the foot toward its extended position.

According to some features of the above aspects, the releasable latch includes a latch stud that extends from the body, a latch key coupled to the foot, a release plunger slidably coupled to the foot, and a latch spring coupled to the foot. The latch key is movable between an engaged position with the latch stud and a disengaged position with the latch stud. The release plunger is in contact with the latch key. The release plunger is movable between a first position wherein the latch key is in the engaged position and a second position wherein the latch key is in the disengaged position. The latch spring is configured to bias the latch key toward the plunger.

According to some features of the above aspects, the retracted position of the arm and the retracted position of blade are each substantially disposed within a perimeter of the body. The blade has an outer edge that is shaped to substantially match the perimeter of the body. The retracted position of the handle is at least partially disposed within the perimeter of the body. The retracted position of the foot is in contact with at least a portion of a perimeter of the body.

### BRIEF DESCRIPTION OF THE DRAWINGS

FIG. 1 shows a perspective view of an exemplary embodiment of a holder, according to certain aspects of the present disclosure.

FIG. 2 shows a top view of an exemplary embodiment of a knife in its extended position with the trigger plate removed, according to certain aspects of the present disclosure.

FIG. 3 shows a bottom view of the exemplary embodiment of FIG. 2, according to certain aspects of the present disclosure.

FIG. 4 shows an exploded view of the exemplary embodiment of FIG. 2, according to certain aspects of the present disclosure.

FIG. 5 shows an enlarged bottom view of the arm and upper body plate with other items removed, according to certain aspects of the present disclosure.

FIG. 6A shows an enlarged perspective view of the release button, arm and lower body plate with other items removed, according to certain aspects of the present disclosure.

FIG. 6B shows an exploded perspective view of the release button, arm and lower body plate with other items removed, according to certain aspects of the present disclosure.

FIG. 6C shows an exploded perspective view of the release button, upper body plate, lower body plate and stop, according to certain aspects of the present disclosure.

FIG. 7A shows a top view of the knife embodiment of FIG. 2 when seated on the holder embodiment of FIG. 1 with the trigger plate present, according to certain aspects of the present disclosure.

FIG. 7B shows a top view of the exemplary knife embodiment of FIG. 2 when seated on the exemplary holder embodiment of FIG. 1 with the trigger plate removed, according to certain aspects of the present disclosure.

FIG. 7C is a partial cross-sectional view taken generally along line 7C-7C shown in FIG. 7A, according to certain aspects of the present disclosure.

FIG. 8 shows a side view of the exemplary knife and holder embodiments of FIG. 7A, according to certain aspects of the present disclosure.

FIG. 9 shows a perspective view of the exemplary knife and holder embodiments of FIG. 7A with the trigger plate removed, according to certain aspects of the present disclosure.

FIG. 10 shows the items of FIG. 5 with the blade included and arm and blade in their retracted positions, according to certain aspects of the present disclosure.

FIG. 11A shows an enlarged perspective view of an exemplary drum assembly, according to certain aspects of the present disclosure.

FIG. 11B shows a bottom view of the exemplary drum assembly of FIG. 11A, according to certain aspects of the present disclosure.

FIG. 12 shows another exemplary embodiment of the knife, according to certain aspects of the present disclosure.

FIG. 13 shows a further exemplary embodiment of the knife, according to certain aspects of the present disclosure.

FIG. 14 shows yet another exemplary embodiment of the knife, according to certain aspects of the present disclosure.

FIG. 15 shows another exemplary embodiment of a self-defense device including a blade, an arm, a handle, and a foot all in their respective extended positions, according to certain aspects of the present disclosure.

FIG. 16 shows the exemplary embodiment of the self-defense device of FIG. 15 including the blade, the arm, the handle, and the foot all in their respective retracted positions, and the latch key in an engaged position with the latch stud, according to certain aspects of the present disclosure.

FIG. 17 shows the exemplary embodiment of the self-defense device of FIG. 15 including the blade, the arm, the handle, and the foot all in their respective retracted positions, and the latch key in a disengaged position with the latch stud, according to certain aspects of the present disclosure.

### DETAILED DESCRIPTION

Various embodiments are described with reference to the attached figures, where like reference numerals are used throughout the figures to designate similar or equivalent elements. The figures are not necessarily drawn to scale and are provided merely to illustrate aspects and features of the present disclosure. Numerous specific details, relationships, and methods are set forth to provide a full understanding of certain aspects and features of the present disclosure, although one having ordinary skill in the relevant art will recognize that these aspects and features can be practiced without one or more of the specific details, with other relationships, or with other methods. In some instances, well-known structures or operations are not shown in detail for illustrative purposes. The various embodiments disclosed herein are not necessarily limited by the illustrated ordering of acts or events, as some acts may occur in different orders and/or concurrently with other acts or events. Furthermore, not all illustrated acts or events are necessarily required to implement certain aspects and features of the present disclosure.

For purposes of the present detailed description, unless specifically disclaimed, and where appropriate, the singular includes the plural and vice versa. The word “including” means “including without limitation.” Moreover, words of approximation, such as “about,” “almost,” “substantially,” “approximately,” and the like, can be used herein to mean “at,” “near,” “nearly at,” “within 3-5% of,” “within acceptable manufacturing tolerances of,” or any logical combination thereof. Similarly, terms “vertical” or “horizontal” are intended to additionally include “within 3-5% of” a vertical or horizontal orientation, respectively. Additionally, words of direction, such as “top,” “bottom,” “left,” “right,” “above,” and “below” are intended to relate to the equivalent direction as depicted in a reference illustration; as understood contextually from the object(s) or clement(s) being referenced, such as from a commonly used position for the object(s) or element(s); or as otherwise described herein.

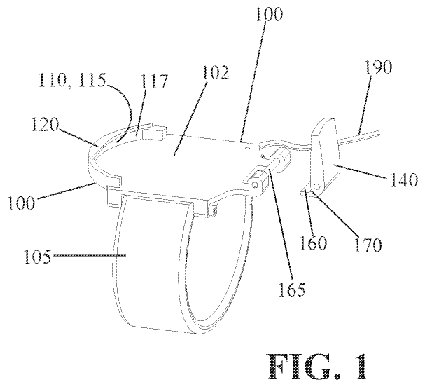

In accordance with an embodiment, FIG. 1 shows a wearable holder 100 and wristband 105. The wristband 105 may be constructed using leather, canvas, nylon, metal, rubber or other material available for use in watch straps or fitness-related wrist straps or wristbands. The wristband 105 engages the holder 100 using screws, pins or other modes of attachment common to watch straps. Similarly, the wristband 105 may be secured around the wrist using a clasp or Velcro interface in a manner common to watch straps or fitness-related straps or wristbands.

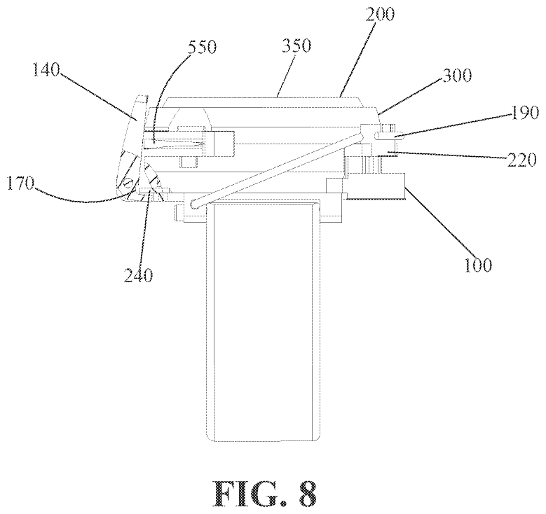

As shown most clearly in FIG. 1, the holder 100 includes a holder base 102 and pocket 110 defined by a pocket channel 115, launch shoulder 120 and launch wall 117. A trigger 140 pivots relative to the holder base 102 using a trigger pin 165. The trigger 140 includes a ledge 160 and trigger groove 170. The trigger 140 pivots between an engaged position shown in FIGS. 1 and 8, and disengaged position in a manner described further below. A tether 190, made of nylon, paracord, wire or other flexible/durable material is fastened to the holder 100 at one end and an anchor 260 or the like fixed to the knife 200 at the other end.

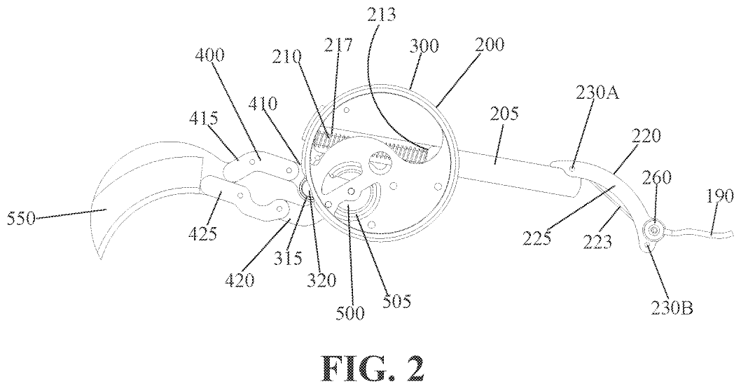

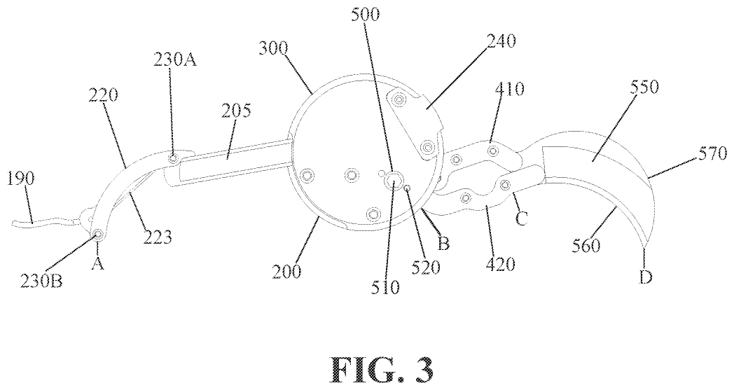

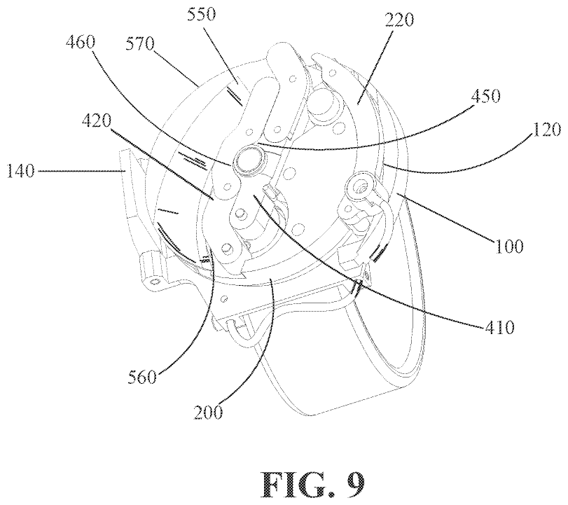

As shown in FIGS. 2-4, the knife 200 includes a foot 220, handle 205, body 300, arm 400 and blade 550. The foot 220 resembles a clevis with opposing wings 225A, 225B connected by foot pins 230A, 230B at proximate and distal ends. A foot spring 223, which may be in the form of a leaf spring, torsion spring or other resilient member, is preferably anchored near foot pin 230B. The proximate end of the foot 220 is pivotably coupled to a distal end of the handle 205 using foot pin 230A. This arrangement enables the foot 220 to pivot relative to the handle 205 between a retracted position (shown, for example, in FIG. 9) and extended position (shown in FIGS. 2-3). At the proximate end of the foot, one end of the foot spring 223 engages a surface of the handle 205 to bias the foot 220 toward the extended position.

As shown in FIGS. 8-9, the foot 220 can be formed with a curve that substantially matches the curve of the body 300, such that when the foot is folded into its retracted position with the knife 200 seated, at least a portion of the foot substantially matches the circular perimeter of the body 300.

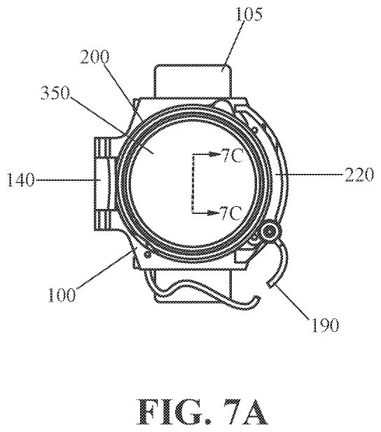

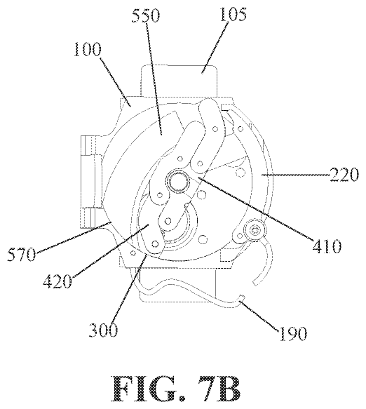

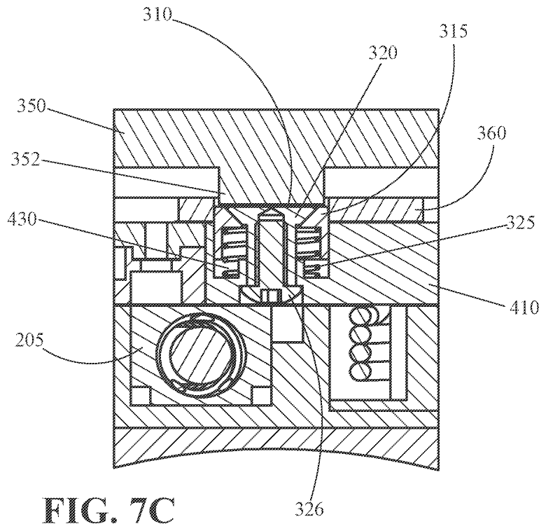

The handle 205 is slideably received into a handle channel 370 formed by opposing upper and lower body plates 360, 380. The inner walls of the handle 205 form a handle cavity 213 that houses a handle spring 217 (or other resilient member) arranged around a spring guide pin 210 in a manner that biases the handle 205 from a retracted position (shown in FIGS. 7-9) toward an extended position (shown in FIGS. 2-4). As the handle 205 travels toward the extended position, a protrusion 215 or the like, formed near the end of the handle's outer wall engages a surface of the body 300 to prevent the handle from fully disengaging from the body 300.

The body 300, substantially formed by the upper and lower body plates 360, 380 may have a round form (disk-shaped or circular-shaped) in a manner that resembles a wristwatch. A trigger plate 350 sits within the perimeter of a circular wall formed at the top surface of the upper body plate 360. The trigger plate 350 is retained at its perimeter by a circular retaining ring 351. In one embodiment the trigger plate 350 is a single layer disk made of metal or glass (resembling a wristwatch crystal), for example. In other exemplary embodiments, the trigger plate 350 may comprise a multi-layer assembly that houses a functioning digital or mechanical watch dial or one of many other wearable electrical devices having a digital display and a sufficiently flat form factor. Under such embodiments, the body 300 and wristband 105 can function as, and resemble, a wristwatch or other wearable device when the body is in the engaged position.

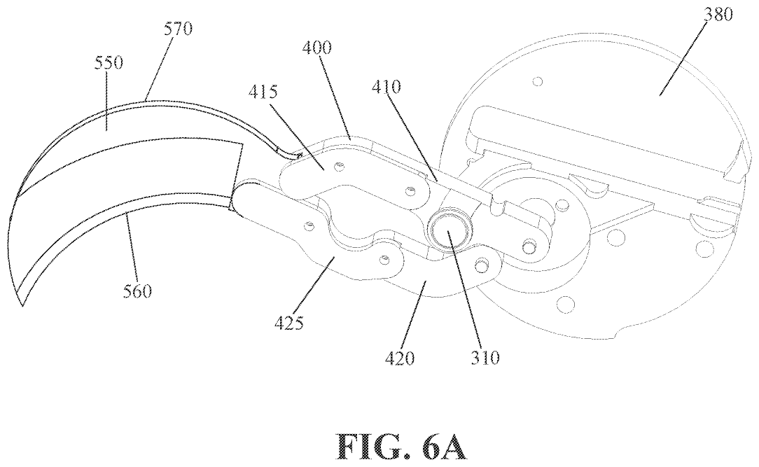

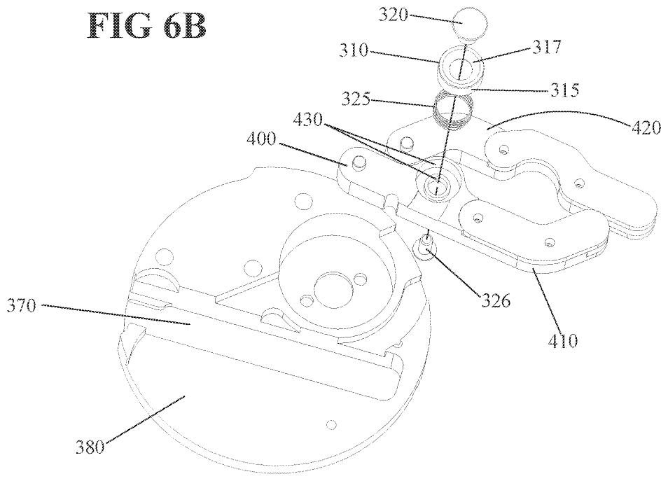

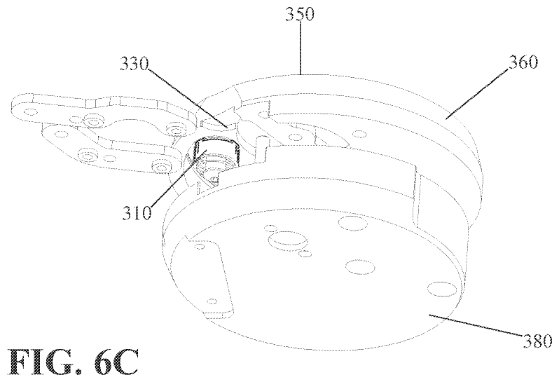

As shown most clearly in FIGS. 6A-6C and 7C, the knife may include a release button 310 comprising a cap 320 and collar 315 having a taper 317 where the collar 315 is adapted to slideably receive the cap 320. An upper bore 430 formed within the upper link 410 of the arm 400 (discussed further below) slideably receives the release button 310, such that the release button 310 travels in an axial direction relative to the upper link 410 between raised and lowered positions. As shown most clearly in FIG. 6B, a button spring 325 (in the form of a coil spring or other resilient member) rests between outer and inner portions of the upper bore 430 formed on the upper link 410, and presses on the under-surface of the collar 315 in a manner that biases the release button 310 toward the raised position (i.e. toward trigger plate 350).

As shown most clearly in FIG. 7C, a boss 352 formed on the undersurface of the trigger plate 350 communicates through an aperture in the upper body plate 360 to make contact with the cap 320 and to urge the release button 310 toward its lowered position when the trigger plate 350 is pressed. A button head screw 326 or the like holds components of the release button 310 together and maintains them in the upper bore 430.

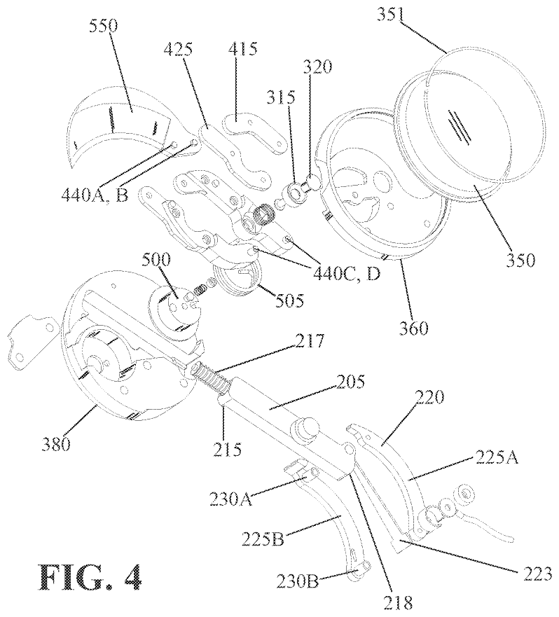

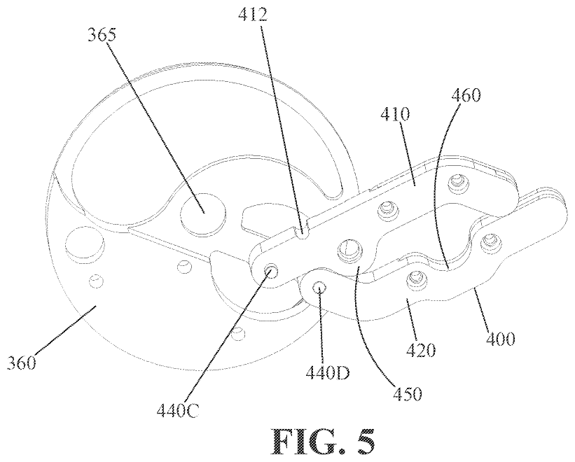

As shown most clearly in FIGS. 4-5, an arm assembly 400 operates as a 4-bar linkage comprising an upper link 410, lower link 420 and four linkage pivot elements 440A-D representing the four corners of the 4-bar linkage. Pivot elements 440A-D may be formed from protrusions or pins extending from the upper link 410, lower link 420 and blade 550. Opposing apertures engage pivot elements 440A-D to effectuate pivoting movement. Pivot elements 440A, B are spaced apart at a proximate end of the blade 550 and pivot elements 440C, D are similarly spaced apart in positions relative to the body 300 to form opposing linkage elements on the body 300 and blade 550 and to connect the upper and lower linkages. Under this arrangement, the arm's 4-bar linkage is permitted to pivot between extended and retracted positions shown, respectively, in FIGS. 6A and 9. A drum assembly 500, equipped with a torsion drum spring 505 (or other resilient member), acts to bias the arm toward its extended position.

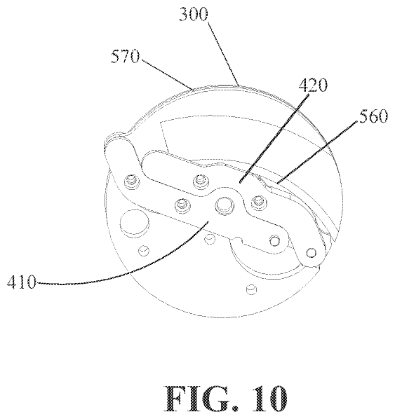

FIGS. 5 and 10 show opposing interlocking shapes (such as protrusion 450 and cutout 460) formed in the upper 410 and lower 420 linkages, thereby allowing the linkages to collapse into each other in their retracted positions.

FIG. 6A shows and an upper link cap 415 and lower link cap 425. The link caps allow users to easily change blades by removing screws and not having to press out pins. For example, a user may want to install a dull practice blade for training and later replace it with a sharp blade for use in operation.

As most clearly shown in FIG. 3, the blade 550 has a hook shaped form with a sharp interior edge 560 and dull exterior edge 570. When formed in this manner the hook shaped blade form emulates a cat's claw to provide aggressive penetration desired for a defensive, pull-oriented cutting motion. The present disclosure recognizes that a pulling motion is instinctual in close contact self-defense situations, particularly when an attacker approaches from behind the user and places their arm across the user's neck, chest or waist. While a user can apply a pulling motion with a conventional straight blade, straight blades ride out of the cutting surface, while the curved blade with its extreme point digs in.

As shown in FIGS. 7B, and 8-10, at least a portion of the blade's exterior edge 570 can be formed with a curve that substantially matches the curve of the body 300, such that when the blade 550 is folded into its retracted position, at least a portion of the blade's exterior edge 570 substantially matches the circular perimeter of the body 300 to provide a form factor similar to that of a wristwatch. When retracted, the curved shape of the blade 550 also allows for other components or structure to be disposed in the area immediately adjacent to the curve of the sharp interior edge 560, as shown in FIGS. 9-10.

FIGS. 8-9 show the knife 200 and all components in their retracted positions and the trigger 140 in its engaged position. This arrangement enables the knife to rest securely within the holder 100 in a seated position with the launch shoulder 120 received between the wings of the foot 220. In this position, the trigger groove 170 engages a substantially flat catch plate 240 fixed to the body, which provides a detent fit that prevents the ledge from pivoting and keeps the knife retained in its seated position, with the handle 205 and foot 220 substantially collapsed into the body 300 in their retracted positions. When the knife 200 is in its retracted position, the foot 220, handle 205, arm 400 and blade 550 each substantially retract into the body 300, such that each of these components are at least substantially disposed within the perimeter of the body, with no more than portions of these components extending beyond that perimeter.

FIG. 7C shows the release button 310 when the knife is retracted. The release button 310 rests in its raised position above the upper surface of the handle 205 and inside bore 430 formed near the center of the upper body plate 360. When in its retracted position, the handle 205 prevents axial/downward movement of the trigger plate 350 and release button 310 toward their lowered positions. Specifically, button head screw 326 contacts the upper surface of the handle 205, thereby preventing downward movement of the cap 320 fastened to button head screw 326. This arrangement acts as a safety measure to prevent unintended depression of the trigger plate, 350 and lowering of the release button 310, which would, in-turn, unintentionally extend and expose the blade 550 in the manner discussed below.

Providing a release button 310 with a separate collar 315 and cap 320, rather than a one-piece release button, advantageously allows the collar 315 to carry a shear load applied by the upper link 410 (originating from the drum spring 505 discussed further below) when the upper link 410 is in its retracted position. This shear load may, under certain circumstances, impede movement by the collar 315 within bore 430. Providing a release button with a separate collar 315 and cap 320, with the collar carrying the shear load, reduces the risk of similarly impeding movement by the cap and button head screw, which could otherwise translate to undesired consequences, such as impeding movement by the handle 205 under certain operational conditions.

The user unseats the knife by flipping the top of the trigger 140, thereby causing the trigger to pivot and trigger grove 170 to disengage from the catch plate 240. Disengaging the trigger allows the foot 220 to pivot toward its extended position, as urged by the foot spring 223 and the handle spring 217 to propel the knife outward relative to the launch wall 117. As the knife launches, the tether 190 acts to keep the knife 200 attached to the holder and accessible to the user. In an alternative embodiment, the holder itself may be equipped with a resilient member disposed proximate to the launch wall 117 or the like. Under this alternative embodiment components of the holder cause the knife 200 to propel outward.

The user may grip the knife 200 with the foot 220 and handle 205 extended and while the blade 550 is still retracted. FIG. 3 shows that the foot 220, handle 205 and body 300 form an arched shape, which provides a natural gripping contour. The curvature of the foot 205 invites contact with a pinky finger and gives an immediate indication that the knife 200 is being held in a preferred orientation such that the blade's tip (point D in FIG. 3) will be substantially oriented away from the user's hand when the blade 550 reaches its extended position. This preferred orientation enables an effective downward or sideways slashing/cutting motion. If gripped in the opposite direction, however, the user can still cause the blade 550 to extend (in the manner described below) and the blade 550 can still provide an effective defense using a pulling motion during use.

When in its extended position, the handle 205 is no longer disposed below the release button. This arrangement allows the user to depress the trigger plate 350 and cause axial movement of the release button 310 toward its lowered position. As the release button 310 continues to move toward its lowered position, it ultimately exits the bore 430 thereby allowing the drum spring 505 to urge the arm 400 and blade 550 toward the extended position shown in FIGS. 2-3. As the arm moves toward its extended position, the release button 310 (seated within the upper arm bore 430 of the upper link 410) travels with the upper link 410 until it reaches the lockout notch 330 (shown in FIG. 6C). At this point, the coil spring urges the release button 310 toward its raised position where it rests against the lockout notch 330, thereby locking the arm 400 and blade 550 in their extended positions and preventing any unintentional pivoting of the arm linkages or corresponding retraction of the blade.

When extended and locked, the knife 200 is grasped by the fingers and thumb in a manner similar to a traditional knife. The proportions, angles and shapes shown in the figures (which are substantially drawn to scale) enable the knife 200, confined to a wristwatch-like form factor in its retracted position, to expand to approximately 3.5 times its retracted length in its extended position when accounting for the foot, handle, body, arm and blade. In the exemplary embodiment shown in FIG. 3, the full length of the knife extends for 13.5 cm between reference points A and D providing sufficient leverage for effective use. A graspable portion that includes the foot, handle, and body extends for 7.9 cm between reference points A and B in FIG. 3. The graspable portion may also include the arm, thereby extending the available graspable portion to 10 cm between reference points A and C in FIG. 3

The user depresses the release button 310 to fold the blade 550 and arm 400 back into their retracted positions. When the release button 310 is fully depressed, it ultimately clears the lower edge of the lockout notch 330. This allows the arm 400 and release button 310 to pivot until the release button reaches the release bore 365, where the release button snaps toward its raised position inside the release bore 365, as urged by the button spring 325. This locks the blade 550 in the retracted position.

To return the knife 200 to the seated position within the holder 100, the user guides the foot 220 toward the launch shoulder 120 allowing the shoulder to be received between the wings of the foot 225A, B when in its retracted position. Pressing the foot 220 and distal end of the handle against the launch wall 117 causes the handle 205 and foot 220 to collapse into their retracted positions. With the blade, arm, handle and foot in their retracted positions, this allows the user to pivot the trigger toward its engaged position such that the knife is fully seated within the holder, as shown in FIGS. 8-9.

In exemplary embodiments, unless otherwise specified, the components of the present invention may be constructed of stainless steel or other durable material common to traditional pocket knives.

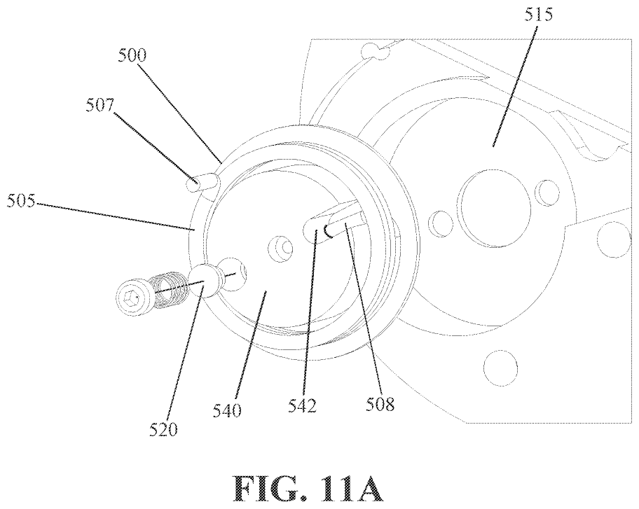

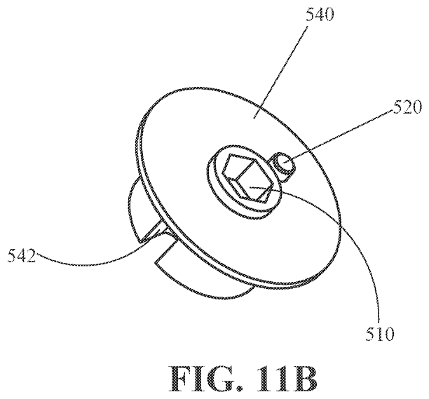

FIGS. 11A, 11B show an embodiment that includes a drum assembly 500 seated within a pocket 515. The drum assembly 500 includes a winding socket 510, drum pin 520, drum spring 505 and rotatable drum 540. A protrusion or turn 507 at the first end of the drum spring engages an indentation 412 in the upper link 410. A second protrusion or turn 508 at the other end of the drum spring 505 engages an indentation 542 in the perimeter of the rotatable drum 540. The drum spring 505 may be tensioned/wound (or conversely unwound) by inserting a hexagon wrench or the like into the winding socket 510 and causing the drum 540 and second protrusion 508 to rotate. When tensioned, the drum pin 520 (which is urged outward by a spring) snaps into an aperture to prevent the drum 540 from rotating more. If tensioned, the drum spring 505 can cause the arm 400 and blade 550 to instantly snap into their extended positions using the trigger plate 350 and release button 310 in the manner described above. If the drum spring 505 is unwound, the arm 400 and blade 550 extend manually.

The wearable self-defense device of the present application allows users to quickly arm through two actions that can occur in less than a second: (1) actuating the trigger 140 to instantly launch the knife 200 and spring the foot and handle toward their extended positions, and consequently propel the device into the user's hand; and (2) applying any form of pressure to the trigger plate 350, including simply grasping the body 300, to instantly spring and lock the arm 400 and blade 550 into their extended positions. Once in its extended position, the knife 200 provides a rigid, durable and effective self-defense apparatus capable of inflicting substantial damage on an attacker and greatly increasing a user's chance of escape.

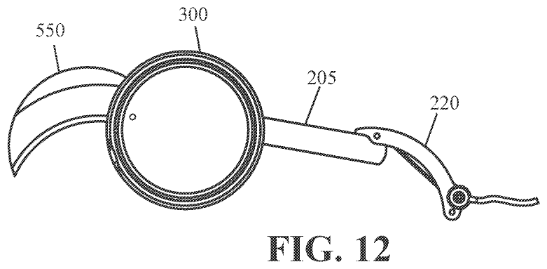

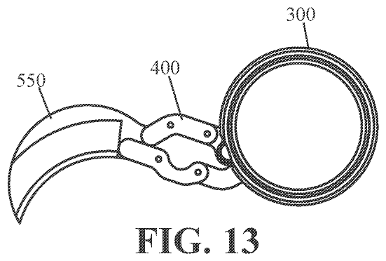

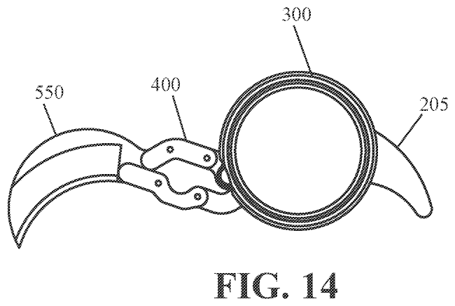

It will be appreciated that alternative embodiments may also include a knife consisting of a blade 550, body 300, handle 205 and foot 220 as shown in FIG. 12. FIG. 13 shows another alternative embodiment of the knife consisting of a blade 550, arm 400 and body 300. FIG. 14 shows another alternative embodiment of the knife consisting of a blade 550, arm 400, body 300, with a handle 205 that is substantially fixed to the body. In a variation of the embodiment of FIG. 14, the handle 205 may be permitted to move between extended and retracted positions, where the handle acts to prevent extension of the arm and blade in the manner similar to the embodiment of FIG. 2.

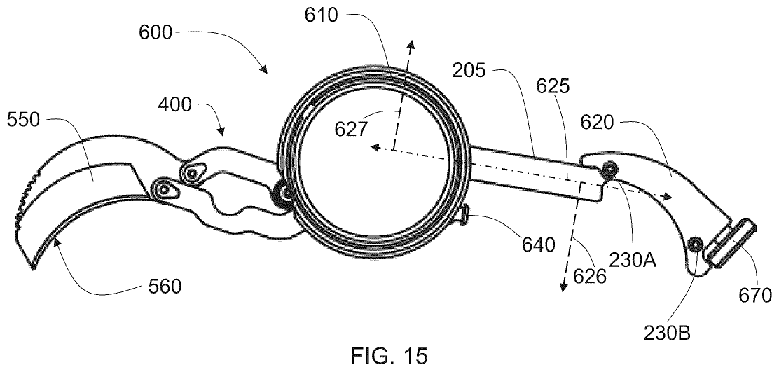

Regarding FIG. 15, in another embodiment, a self-defense device 600 is shown including a blade 550, an arm 400, a body 610, a handle 205, and a foot 620. The handle 205 is coupled to the body 610, and the arm 400 is coupled to the body 610 and to the blade 550. The handle 205, the arm 400, the foot 620, and the blade 500 are each configured to move relative to the body 610 between a retracted position and an extended position. The blade 550, the arm 400, the handle 205, and the foot 620 are shown in FIG. 15 in their respective extended positions. The blade 550, the arm 400, and the handle 205 in this embodiment are substantially similar to the same components for the embodiments described above, and operate to extend and retract in the same way.

The foot 620, like the foot 220, resembles a clevis and includes opposing wings connected by foot pins 230A, 230B. A foot spring 223 (see FIG. 2), which may be in the form of a leaf spring, torsion spring, or other resilient member, is preferably anchored near foot pin 230B. The proximate end of the foot 620 is pivotably coupled to a distal end of the handle 205 using the foot pin 230A. The foot 620 pivotally extends from a retracted position to an extended position in response to a bias of the foot spring 223.

However, as will be described, there are differences between the self-defense device 600 and the prior described embodiments. For example, the self-defense device 600 is a standalone device that lacks a holder 100. Therefore, the handle 205 and the foot 620 are not maintained in a retracted position by the holder 100. As will be described in detail, the body 610 and the foot 620 include additional features not present in the embodiments described above.

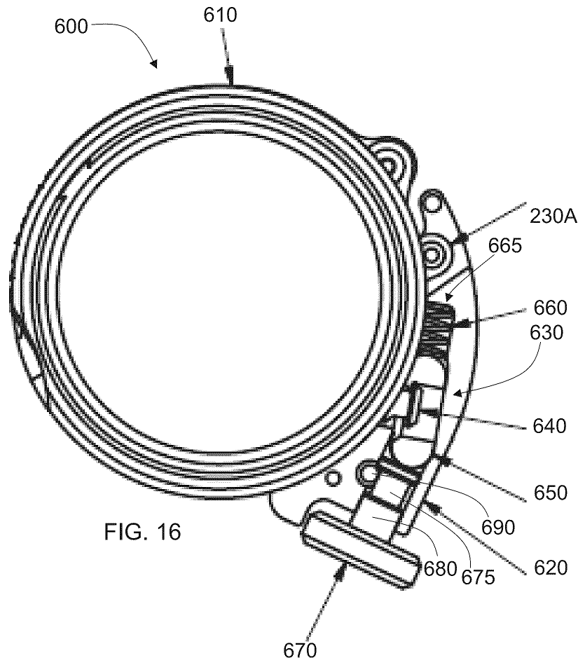

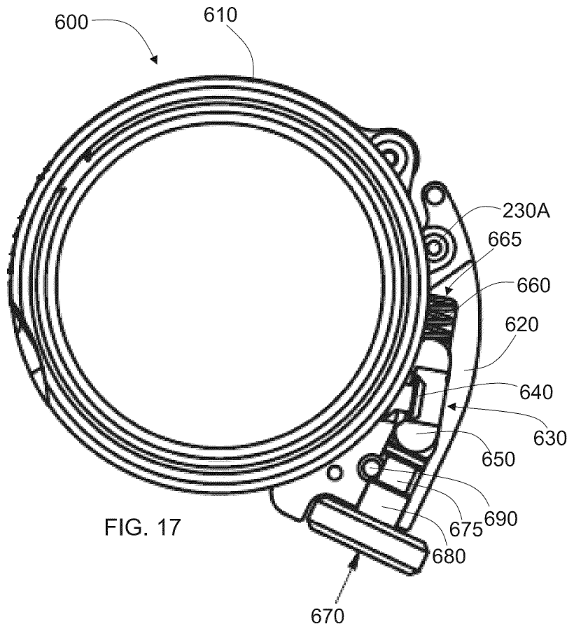

Referring to FIGS. 16 and 17, the self-defense device 600 is shown with the blade 550, the arm 400, the handle 205, and the foot 620 in their respective retracted positions. As is evident from FIGS. 16 and 17, in the retracted position the blade 550, the arm 400, and the handle 205 are substantially inside the body 610, and are therefore not substantially visible when retracted. However, the foot 620 in the retracted position is in contact with and disposed around at least a partial perimeter of the body 610. The foot 620 is shown with the top opposing wing being transparent or not included such that components internal to the foot 620 are visible.

In this embodiment, the foot 620, and also the handle 205, via its pivotal coupling with the foot 620, are held in the retracted position by a releasable latch 630. In an embodiment, the releasable latch 630 comprises a latch stud 640 and a latch key 650. The latch stud 640 is fixedly coupled to and extends from the body 610. The latch key 650 is slidably coupled within the foot 620 so that it can move between an engaged position with the latch stud 640 as shown in FIG. 16 and a disengaged position with the latch stud 640 as shown in FIG. 17. A resilient member 660, for example, a latch spring 660 is held within the handle 620, for example within a channel 665, with the latch key 650, and biases the latch key 650 into an engaged position with the latch stud 640.

In an embodiment, a release plunger 670 is slidably coupled to the foot 620, for example by being captured within the channel 665. For example, the release plunger has a recessed portion 675 of a shaft 680 that is free to move longitudinally within the channel 665 relative to a pin 690, but the pin 690 constrains the release plunger 670 to remain coupled to the foot 620 within the channel 665. The release plunger 670 is in contact with the latch key 650 such that applying a force on the release plunger 670 in a direction toward the latch key 650 moves the latch key 650 against the bias of the latch spring 660. FIG. 16 shows the release plunger 670 positioned such that the latch key 650 is engaged with the latch stud 640. FIG. 17 shows the release plunger 670 positioned, for example, in response to a release force being applied, such that the latch key 650 is disengaged from the latch stud 640. It should be noted that because the foot 620 is pivotably coupled to a distal end of the handle 205 as indicated by the pivotal coupling 230A, the foot 620 is configured to pivot relative to the handle 205 between a retracted position and an extended position. Thus, the releasable latch 630 holds both the foot 620 and the handle 205 in their respective retracted positions.

Referring to FIG. 15, when the blade 550, the arm 400, the handle 205, and the foot 620 of the self-defense device 600 are in their extended positions, a centerline 625 through the handle 205 defines a first direction 626 and a second direction 627 transverse to the centerline 625. In an embodiment, the foot 620 is curved and the blade 550 has a curved interior edge 560, such that both the foot 620 in its extended position the blade 550 in its extended position extend in the first direction 626 transverse to the centerline 625 of the handle 205 in its extended position.

While the present disclosure has been described with reference to one or more particular embodiments or implementations, those skilled in the art will recognize that many changes may be made thereto without departing from the spirit and scope of the present disclosure. Each of these implementations and obvious variations thereof is contemplated as falling within the spirit and scope of the present disclosure. It is also contemplated that additional implementations according to aspects of the present disclosure may combine any number of features from any of the implementations described herein.

What is claimed is:

1. A self-defense device comprising:
a handle, a body, an arm, and a blade;
the handle coupled to the body;
the arm coupled to the body and to the blade;
the handle, the arm, and the blade each configured to move relative to the body between a retracted position and an extended position; and
a releasable latch configured to hold the handle in the retracted position.

2. The self-defense device of claim 1, further comprising:
a foot pivotably coupled to a distal end of the handle, the foot configured to pivot relative to the handle between a retracted position and an extended position, the foot held in the retracted position by the releasable latch.

3. The self-defense device of claim 2, wherein the releasable latch comprises:
a latch stud that extends from the body; and
a latch key coupled to the foot, the latch key movable between an engaged position with the latch stud and a disengaged position with the latch stud.

4. The self-defense device of claim 3, further comprising a latch spring coupled to the foot, the latch spring configured to bias the latch key toward the engaged position with the latch stud.

5. The self-defense device of claim 3, further comprising:
a release plunger slidably coupled to the foot, the release plunger in contact with the latch key, the release plunger movable between a first position wherein the latch key is in the engaged position with the latch stud and a second position wherein the latch key is in the disengaged position with the latch stud.

6. The self-defense device of claim 1, wherein
the retracted position of the arm and the retracted position of blade are each substantially disposed within a perimeter of the body, the blade having an outer edge that is shaped to substantially match the perimeter of the body; and
the retracted position of the handle is at least partially disposed within the perimeter of the body.

7. The self-defense device of claim 6, wherein the arm comprises a linkage mechanism including opposing first and second linkage elements, each of the first and second linkage elements pivotally coupled at a first end to the body and pivotally coupled at a second end to the blade such that each of the first and second linkage elements is configured to pivot between a retracted position substantially inside the body and an extended position extending outside of the body.

8. The self-defense device of claim 7, further comprising a release button disposed within the first linkage element, the release button movable relative to a surface of the first linkage element between a raised position and a lowered position, wherein when the release button is in its raised position and the arm is in its retracted position, the release button interferes with the body to prevent the arm from moving toward its extended position.

9. The self-defense device of claim 8, wherein
the body further comprises an elongated channel configured to slidably receive and house the handle in its retracted position, wherein
the handle in its retracted position makes contact with the release button when the release button is in its raised position and the arm is in its retracted position, thereby preventing the release button from moving from its raised position to its lowered position, and wherein
the handle in its extended position does not contact the release button when the release button is in its raised position and the arm is in its retracted position, thereby permitting the release button to be moved from its raised position to its lowered position.

10. The self-defense device of claim 9, further comprising a depressible trigger plate movable relative to the body between raised and lowered positions, the depressible trigger plate in contact with the release button when the release button is in its raised position and the arm is in its retracted position, and wherein movement of the depressible trigger plate toward its lowered position when the handle is in its extended position causes the release button to move toward its lowered position.

11. The self-defense device of claim 8, wherein when the release button is in its lowered position and the arm is in its retracted position, the arm is free to move toward its extended position.

12. A self-defense device comprising:
a foot, a handle, a body, an arm, and a blade;
the foot coupled to the handle;
the handle coupled to the body;
the arm coupled to the body and to the blade;
the foot, the handle, the arm, and the blade each configured to move relative to the body between a retracted position and an extended position;
a releasable latch configured to hold the foot and the handle in their retracted positions.

13. The self-defense device of claim 12, wherein the foot is pivotally coupled to a distal end of the handle and configured to pivot relative to the handle between the retracted position and the extended position, and a first resilient member is configured to bias the foot toward its extended position.

14. The self-defense device of claim 13, wherein the body further comprises an elongated channel configured to slidably receive and house the handle is in its retracted position, the elongated channel further configured to house a second resilient member that biases the handle toward its extended position.

15. The self-defense device of claim 14, wherein the releasable latch comprises:
a latch stud that extends from the body;
a latch key coupled to the foot, the latch key movable between an engaged position with the latch stud and a disengaged position with the latch stud;
a release plunger slidably coupled to the foot, the release plunger in contact with the latch key, the release plunger movable between a first position wherein the latch key is in the engaged position and a second position wherein the latch key is in the disengaged position; and
a latch spring coupled to the foot, the latch spring configured to bias the latch key toward the plunger.

16. The self-defense device of claim 15, the arm comprising:
a linkage mechanism including opposing first and second linkage elements, each of the first and second linkage elements pivotally coupled at a first end to the body and pivotally coupled at a second end to the blade such that each of the first and second linkage elements is configured to pivot between a retracted position substantially inside the body and an extended position extending outside of the body; and
a third resilient member configured to bias the first linkage element toward its extended position.

17. The self-defense device of clam 16, wherein the foot is curved and the blade has a curved interior edge, such that both the foot in its extended position and the blade in its extended position extend in a direction transverse to a centerline of the handle in its extended position.

18. A self-defense device comprising:
a foot, a handle, a body, an arm, and a blade;
the foot coupled to the handle;
the handle coupled to the body;
the arm coupled to the body and to the blade;
the foot, the handle, the arm, and the blade each configured to move relative to the body between a retracted position and an extended position;
a releasable latch configured to hold the foot and the handle in their retracted positions;
a first resilient member that biases the blade and the arm toward their extended positions;
a second resilient member that biases the handle toward its extended position; and
a third resilient member that biases the foot toward its extended position.

19. The self-defense device of claim 18, wherein the releasable latch comprises:
a latch stud that extends from the body;
a latch key coupled to the foot, the latch key movable between an engaged position with the latch stud and a disengaged position with the latch stud;
a release plunger slidably coupled to the foot, the release plunger in contact with the latch key, the release plunger movable between a first position wherein the latch key is in the engaged position and a second position wherein the latch key is in the disengaged position; and
a latch spring coupled to the foot, the latch spring configured to bias the latch key toward the plunger.

20. The self-defense device of claim 19, wherein
the retracted position of the arm and the retracted position of blade are each substantially disposed within a perimeter of the body, the blade having an outer edge that is shaped to substantially match the perimeter of the body;
the retracted position of the handle is at least partially disposed within the perimeter of the body; and
the retracted position of the foot is in contact with at least a portion of a perimeter of the body.
